(19) United States
(12) Patent Application Publication
(10) Pub. No.: US 2010/0278164 A1
(43) Pub. Date: Nov. 4, 2010

(54) Method, Base Station, Mobile Station, Telecommunication System, and Computer Program for Detecting a WLAN

(76) Inventors: Anne-Lott Hedberg, Lund (SE); Regina Johannesson, Lund (SE)

Correspondence Address: COATS & BENNETT, PLLC, 1400 Crescent Green, Suite 300, Cary, NC, 27518, US

(21) Appl. No.: 12/809,786

(22) PCT Filed: Dec. 15, 2008
(86) PCT No.: PCT/EP08/67506

§ 371 Date: Jun. 21, 2010

Related U.S. Application Data
(60) Provisional application No. 61/020,463, filed on Jan. 11, 2008.

(30) Foreign Application Priority Data
Dec. 21, 2007 (EP) 07150381.7

(51) Int. Cl. H04W 40/00

(52) U.S. Cl. 370/338

(57) ABSTRACT

A method comprising operating a base station is disclosed. The operating consists of providing synchronisation for mobile stations; and broadcasting information comprising information about an access point enabling generic access network, GAN, communication, from the base station operating a pure broadcasting telecommunication cell. An access area of the access point and the pure broadcasting telecommunication cell cover essentially the same area. Therefore, mobile stations able to receive the broadcasting information become aware of accessibility to the access point. Corresponding base station, mobile station, telecommunication system, and computer program are also disclosed.

### TECHNICAL FIELD

The present invention relates to a method of operating a base station, such a base station, a mobile station, a telecommunication system, and a computer program. In particular, the present invention relates to an improved approach for a cellular network and a generic access network present within the coverage area of the cellular network.

### BACKGROUND

Generic Access Network (GAN) is a technology that enables telecommunication service, such as GSM and WCDMA service, to be delivered over broadband access network and wireless local area network (WLAN) or Bluetooth wireless technology.

Cellular phones or other similar mobile equipment with capabilities for GAN communication, e.g. via WLAN, normally search for access to WLAN and/or Bluetooth access points, continuously or periodically. This has been found to consume a non-negligible amount of battery power. Therefore, attempts have been made for power saving purposes, where the cellular system indicates if there is a WLAN reported to be present in the cell in which a mobile station is operating, e.g. as disclosed in WO 2007/117190 A1 or US 2004/0165563 A1. US 2004/0165563 A1 discloses a method and apparatus for detection and selection of WLAN service. A remote station may scan for a cellular paging indicator and a WLAN beacon using one or two tuners. When WLAN coverage is available, a packet data session may be transferred thereto.

Thus, if no WLAN is present, the mobile station does not need to waste energy on searching for it. However, for some situations, a telecommunication cell may cover an area of about 7500 km², as for CDMA450, while the WLAN may only cover a few hundred square meters. In such cases, it can be questioned if the information that a WLAN is present in the cell is of any use, and may also be extra annoying if the user of the mobile station think that her mobile station is working in a power save mode, and then drains the battery anyway, and most probably without finding the announced WLAN. Therefore, there is a need to improve efficiency in WLAN searching with regard to power consumption.

### SUMMARY

The present invention is based on the understanding that a mobile station may waste a lot of energy, and thus a lot of its battery capacity, by searching for a WLAN for access to generic access networks (GAN) communication, although there may not be an available WLAN. The present invention is further based on the understanding that a mobile station normally perform information gaining about its cellular environment. The inventors have by the above demonstrated understandings, and provision of a design using the cellular mechanisms for providing awareness in the mobile station about when a WLAN is available. The inventors have not only found that this will reduce power consumption, it will also increase predictability of success to access the WLAN for the user of the mobile station.

According to a first aspect of the present invention, there is provided a method comprising operating a base station, the operating consisting of providing synchronisation for mobile stations; and broadcasting information comprising information about an access point enabling generic access network, GAN, communication, from the base station operating a pure broadcasting telecommunication cell, wherein an access area of the access point and the pure broadcasting telecommunication cell cover essentially the same area, such that mobile stations able to receive the broadcasting information become aware of accessibility to the access point. An advantage of this is that the mobile station does not have to perform search for WLAN access until it has been aware of WLAN availability by cellular mechanisms. This approach saves power compared to continuously searching for WLAN access according to traditional approaches.

The broadcasted information may further comprise advertising information. Here, advertising means not strictly to sell a product or service to the general public but may include political parties, interest groups, militaries, or other organizations looking for new recruits, organizations providing information, public service announcements, etc. An advantage of this is that the mobile station can get local information by the announcements. Another advantage is that WLAN provision can be advertisement sponsored. A further advantage is that the advertising can enable more user-friendly operation for accessing the WLAN, e.g. the advertising information may include help information for establishing connection to the WLAN.

The method may further comprise providing information about the pure broadcasting telecommunication cell by another base station operating another telecommunication cell, wherein the another telecommunication cell has considerably larger coverage area than an access area of the access point and than the pure broadcasting telecommunication cell, and the pure broadcasting cell is substantially located within the another telecommunication cell. An advantage of this is that the mobile station gains knowledge about the pure broadcasting telecommunication cell from a cell, which the mobile station may already be in communication with. The providing of information about the pure broadcasting telecommunication cell may further comprise including the pure broadcasting telecommunication cell within a neighbour cell list; and providing the neighbour cell list to mobile stations within or in vicinity to the another telecommunication cell. An advantage of this is that an already existing tool for gaining knowledge about cells is used to provide the awareness of the pure broadcasting telecommunication cell, and thus the available WLAN.

According to a second aspect of the present invention, there is provided a base station arranged to operate a pure broadcasting telecommunication cell, the base station comprising a transmitter arranged to broadcast information about an access point enabling generic access network, GAN, communication, wherein the base station is arranged together with the access point such that the pure broadcast telecommunication cell and the access area of the access point cover essentially the same area. An advantage of this is an economically feasible base station for operating a pure broadcasting telecommunication cell, which has limited functionality compared to a normal telecommunication cell. A further advantage is that such a base station is suitable for co-location and co-operation with a WLAN access point.

The pure broadcasting telecommunication cell may be arranged substantially within another telecommunication cell operated by another base station. The another telecommunication cell may have considerably larger coverage area than an access area of the access point, and than the pure broadcasting telecommunication cell. Information about the pure broadcasting telecommunication cell may be provided from the another base station of the another telecommunication cell. The base may further be arranged to broadcast advertising information. The advantages of this are similar to what is demonstrated for similar features of the first aspect of the present invention. According to a third aspect of the present invention, there is provided a mobile station having both abilities for cellular communication and generic access network, GAN, communication, the mobile station having a mode of operation where the mobile station is arranged to, when operating in the operation mode, synchronise with a pure broadcasting base station; and receive broadcast messaging from the pure broadcasting base station about an access point of a GAN from the pure broadcasting base station operating a pure broadcasting telecommunication cell wherein an access area of the access point and the pure broadcasting telecommunication cell cover essentially the same area such that when the mobile station is able to receive the broadcasting information becomes aware of accessibility to the access point. An advantage of this is that the mobile station does not have to perform search for WLAN access until it has been aware of WLAN availability by cellular mechanisms. This approach saves power compared to continuously searching for WLAN access according to traditional approaches.

The mobile station may further be arranged to enable entering the secondary mode of operation upon reception of information about presence of the pure broadcasting telecommunication cell from a base station operating a presently operating two-way telecommunication cell having considerably larger coverage area than the access area of the access point and than the pure broadcasting telecommunication cell, the reception comprising information about the pure broadcasting telecommunication cell located substantially within the presently operating telecommunication cell. An advantage of this is a mobile station able to handle base stations according to the second aspect of the present invention.

The mobile station may further be arranged to start accessing the WLAN for GAN communication when the broadcasting information about the access point is received from the pure broadcasting base station. The mobile station may further be arranged to receive broadcasted advertising information from the pure broadcasting base station. The mobile station may further be arranged to receive a neighbour cell list comprising information about the pure broadcasting telecommunication cell. Advantages of this are similar to what is demonstrated for similar features of the first aspect of the present invention.

According to a fourth aspect of the present invention, there is provided a telecommunication system comprising at least an access point arranged to provide access to a generic access network, GAN; at least a base station according to the second aspect of the present invention arranged to operate a pure broadcasting telecommunication cell associated with the access point; and at least a mobile station according to the third aspect of the present invention arranged to operate with the base station, and the access point.

The telecommunication system may further comprise at least another base station arranged to operate a cell for telecommunication, the another base station providing information about the pure broadcasting telecommunication cell, wherein the pure broadcasting telecommunication cell is located substantially within an area of the cell for telecommunication, and wherein the cell for telecommunication has considerably larger coverage area than the access area of the access point and than the pure broadcasting telecommunication cell. The advantages of these features are similar to what is demonstrated for similar features of the first aspect of the present invention.

According to a fifth aspect of the present invention, there is provided a computer program comprising instructions, which when executed by a processor are arranged to cause the processor to perform the method according to the first aspect of the present invention. Advantages of this are similar to what is demonstrated for similar features of the first aspect of the present invention.

### BRIEF DESCRIPTION OF DRAWINGS

FIG. 1 illustrates a part of a cellular telecommunication system according to an embodiment of the present invention with a base station co-located with an access point.

FIG. 2 illustrates a part of a cellular telecommunication system according to an embodiment of the present invention with a base station operating a cell.

FIG. 3 illustrates a part of a cellular telecommunication system according to an embodiment of the present invention with a plurality of cells operated by base stations.

FIG. 4 is a schematic block diagram functionally illustrating a pure broadcasting base station according to an embodiment of the present invention.

FIG. 5 is a schematic state diagram indicating operation modes of a mobile station present in a telecommunication cell.

FIG. 6 is a schematic block diagram functionally illustrating a pure broadcasting base station according to an embodiment of the present invention.

FIG. 7 is a flow chart schematically illustrating a method for operating the pure broadcasting base station.

FIG. 8 is a flow chart schematically illustrating a method for providing information about the pure broadcasting telecommunication cell.

### DETAILED DESCRIPTION OF EMBODIMENTS

FIGS. 1 to 3 illustrate receivers and transmitters in an exemplary environment of telecommunication cells and coverage areas of radio communication equipment. These are depicted to illustrate the principles of the invention, and the drawings are not to be considered to be drawn into scale.

FIG. 1 illustrates a part of a cellular telecommunication system 100 according to an embodiment of the present invention with a base station 102 co-located with an access point 104 for generic access network (GAN) communication, such as wireless local area network, Bluetooth, etc., transceiver, such that a cell 106 provided by the base station 102 cover essentially the same area as the access area 108 of the access point 104. The base station 102 is a pure broadcasting telecommunication base station, i.e. there is no handover to the base station 102 from a base station on which a mobile station 110 is camping. Instead, the mobile station only synchronises with the base station 102 to be able to receive broadcasting messaging from the base station 102. The broadcasting messaging comprises information about the access point 104. Since the access area 108 and the cell 106 cover essentially the same area, the mobile station 110 will gain knowledge that access to the access point 104 is possible or at least likely as it is possible to synchronise with the base station 102 and receive broadcasting messaging from the base station 102. The broadcasting messaging preferably comprises information about accessing the access point 104, such as protocol, frequencies, etc.

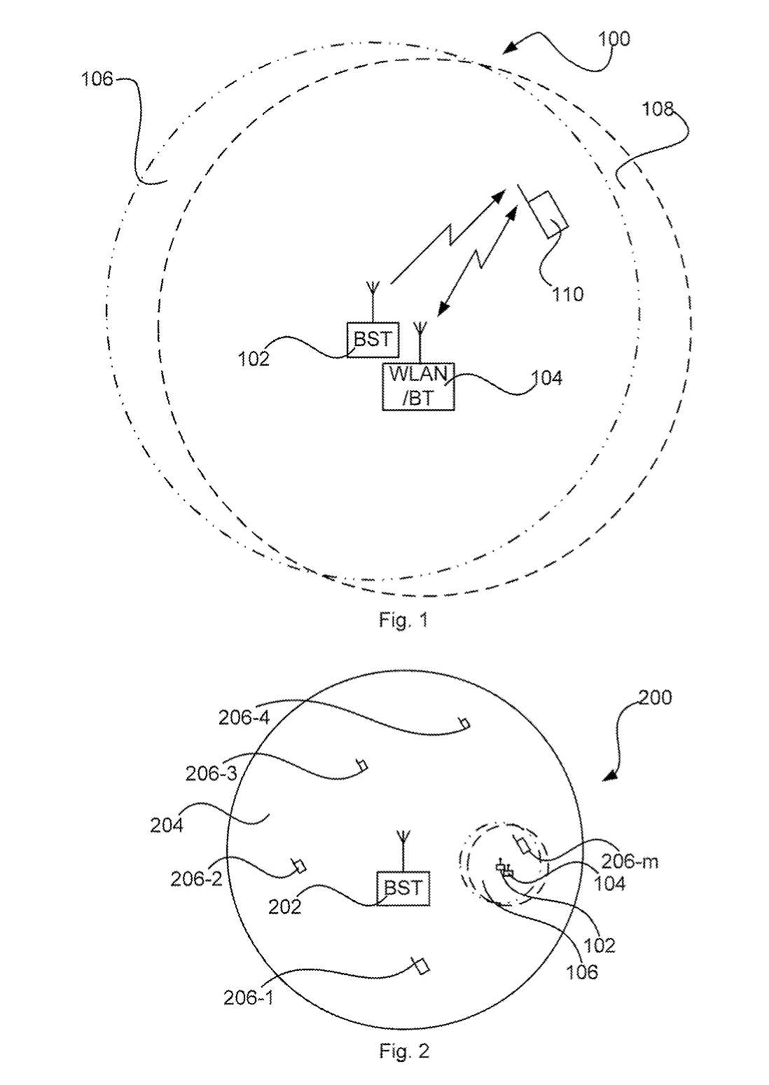

FIG. 2 illustrates a part of a cellular telecommunication system 200 according to an embodiment of the present invention with a base station 202 operating a cell 204. In the cell 204, several mobile stations 206-1, 206-2, . . . , 206-m may be present and be camping on the base station 202, i.e. being in communication with the base station 202 for service according to the abilities of the cellular telecommunication system 200, such as placing or receiving calls, messaging, data communication, etc.

Within the cell 204, there is a pure broadcasting base station 102 co-located with an access point 104, as demonstrated with reference to FIG. 1. The base station 202 provides a neighbour cell list to the mobile stations, which comprises information about the surrounding cells (not shown), and also about the pure broadcasting cell 106. In the neighbour cell list, there is preferably an indication that the pure broadcasting cell 106 is not able for handover. Preferably, there is also information about frequencies, codes, etc. for enabling listening to the pure broadcasting base station 102.

As the mobile stations 206-1, 206-2, . . . , 206-m have the neighbour cell list, they are able to listen for the pure broadcasting base station 102, and when any of the mobile stations 206-1, 206-2, . . . , 206-m is able to receive signals from the pure broadcasting base station 102, and thus able to synchronise and receive broadcasting messaging, it may also access the access point 104 based on the information given by the broadcasting messaging. Thus, the mobile stations do not need to scan for WLAN access on frequencies for WLAN and only need to use the already running mechanism for cellular neighbour cell awareness to gain knowledge if there is an accessible WLAN. Therefore, power can be saved compared to continuously scanning on any available frequencies for WLAN access.

In more detail, information about the pure broadcasting cell operated by the pure broadcasting base station 102 that mobile stations 206-1, 206-2, . . . , 206-m acquires in order to gain knowledge is a cell indicating presence of the access point 104. This information can comprise an identification of the pure broadcasting cell, absolute frequency channel number, base station identity code. The information can be sent directly to a mobile station in question on control information channels, or in a message over messaging services to be activated by the user or an application of the mobile station. This can make the mobile station start acquiring synchronisation information from the pure broadcasting cell, while some mobile stations, e.g. which are not enabled to GAN communication, will ignore the pure broadcasting cell since it for them is just a barred cell on which it is not enabled to be in communication with in ordinary ways for a mobile station in a cellular communication network. Indication on the cell being a barred cell can be comprised in the synchronisation information, e.g. by transmitting only a limited set of synchronisation information.

To further provide simplicity to the handling of pure broadcasting cells, high reuse of frequencies for the pure broadcasting cells can be preferable, e.g. all pure broadcasting cells being assigned the same frequency.

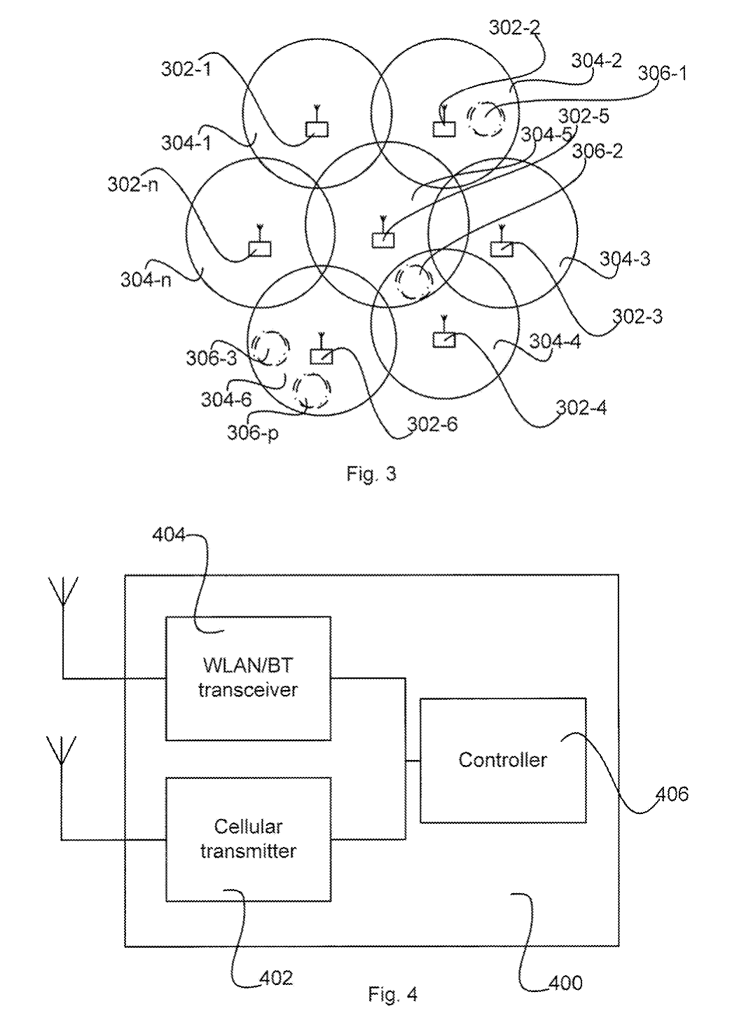

FIG. 3 illustrates a part of a cellular telecommunication system 300 according to an embodiment of the present invention with a plurality of cells 302-1, 302-2, . . . , 302-n operated by base stations 304-1, 304-2, . . . , 304-n, respectively. In some of the cells 302-2, 302-4, 302-5, 302-6, there are one or more pure broadcasting cells 306-1, 306-2, 306-3, . . . , 306-p present substantially within the cells 302-1, 302-4, 302-5, 302-6. As demonstrated with reference to FIG. 1, the pure broadcasting cells are co-located with access points such that their coverage areas substantially overlap. For example, a cell 302-6 can have several such pure broadcasting cells 306-3, . . . , 306-p within its area, a pure broadcasting cell 306-2 can be present substantially within two neighbouring cells 302-4, 302-5, i.e. the pure broadcasting cell 306-2 is located in a boundary zone between the neighbouring cells 302-4, 302-5, and a cell 302-2 can have a single pure broadcasting cell 306-1 within its area.

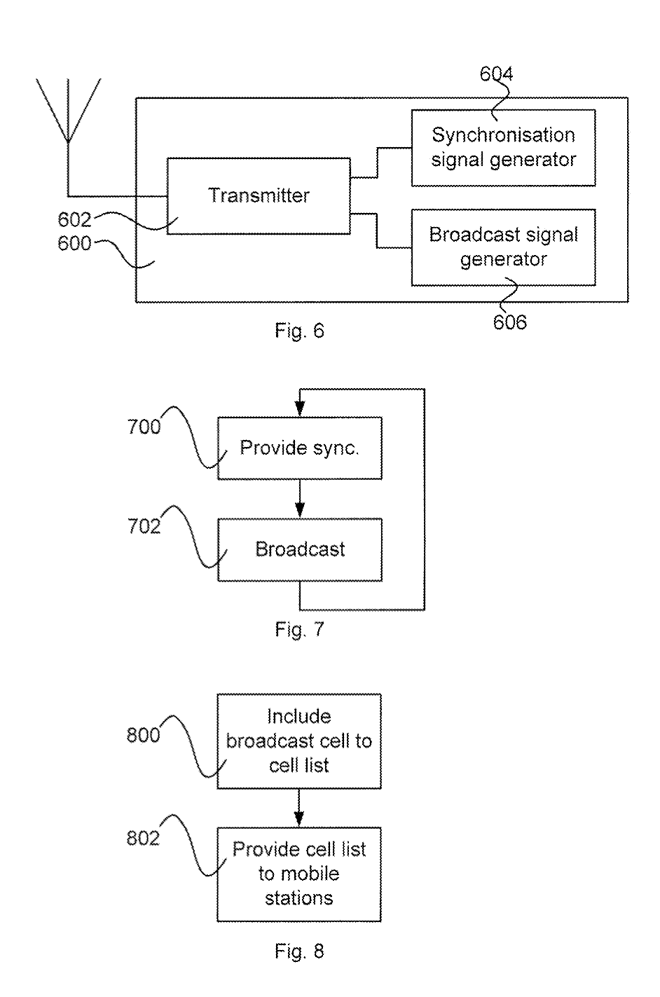

FIG. 4 is a schematic block diagram functionally illustrating a pure broadcasting base station 400 according to an embodiment of the present invention. The base station 400 comprises a cellular transmitter 402 arranged to broadcast information about an access point enabling GAN communication, with a WLAN transceiver 404. It can be arranged as depicted in FIG. 4, i.e. as a joint cellular and WLAN unit, or be in separate, but co-located units, wherein the base station 400 is arranged together with the access point such that the pure broadcast telecommunication cell and the access area of the access point cover essentially the same area. Such an embodiment of the cellular part will be further described with reference to FIG. 6. Returning to FIG. 4, here, the term “cellular transmitter” means that it is a transmitter performing parts of acts normally performed in a cellular base station, e.g. a Node B, but these acts are limited to transmitting signals, i.e. no two-way communication is provided. Thus, no handover is possible to the cellular transmitter 402. On the other hand, the cellular transmitter 402 provides sending of synchronisation and broadcasting signals, and is assigned a cell identification such that its presence can be indicated in a neighbour cell list used in the cellular system. The functions of the cellular transmitter and the WLAN transceiver can be controlled by a controller 406. However, the controller 406 should be construed functionally, and can also be a controller in each of the access point holding the WLAN transceiver 404, and the base station holding the cellular transmitter 402. These controllers can be in communication with each other for controlling their joint functions, such as assignment of frequencies, codes, and/or protocols. Further, these controllers need not to be in communication with each other if their joint functions are predetermined, and their operations can be performed without any communication them between.

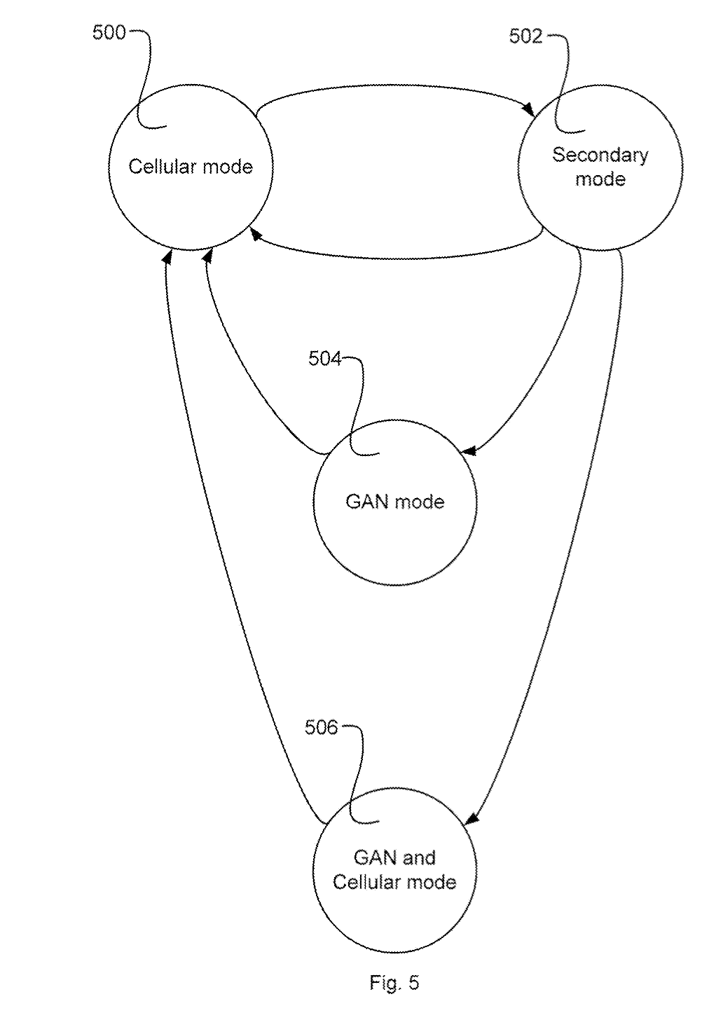

FIG. 5 is a schematic state diagram indicating operation modes of a mobile station present in a telecommunication cell, e.g. as the one depicted in FIG. 2, wherein one or more pure broadcasting telecommunication base stations co-located with access points as demonstrated above are present. When the mobile station is working in a normal cellular mode 500, i.e. being in communication with a base station of the cell in ordinary ways for a mobile station in a cellular communication network, popularly called “camping on the base station”, the mobile station becomes aware of presence of a pure broadcasting base station through the information given in a neighbour list provided by the base station on which the mobile station is camping. Based on this, the mobile station can enter a secondary mode of operation 502 consisting of synchronisation with the pure broadcasting base station, if the signals transmitted by the pure broadcasting base station can be received by the mobile station at its present location. If not, the mobile station returns to the normal cellular mode 500. If synchronisation successful, the mobile station, which is arranged for reception of broadcast messaging from the pure broadcasting base station about an access point, receives broadcasting messaging from the pure broadcasting base station operating the pure broadcasting telecommunication cell. As an access area of the access point and the pure broadcasting telecommunication cell cover essentially the same area, the mobile station able to receive the broadcasting information becomes aware of accessibility to the access point. Then, the mobile station can enter either a pure GAN communication mode 504, i.e. communication is handed over to the WLAN access point, or the mobile station can enter a combined cellular and GAN communication mode 506, where communication is performed both via the WLAN access node and the ordinary cellular system via the base station on which it is camping. It is also possible that the mobile station, although WLAN communication is possible, chooses to not perform any GAN communication, and then the mobile station returns to the normal cellular mode 500. The mobile station is also arranged to return to the normal cellular mode 500 from the GAN communication mode 504, or from the combined cellular and GAN communication mode 506.

It is to be noted that, although WLAN has been used as example above, Bluetooth wireless technology can be used in a similar way for the access point to provide access to a generic access network controller.

FIG. 6 is a schematic block diagram functionally illustrating a pure broadcasting base station 600 according to an embodiment of the present invention. The base station 600 comprises a cellular transmitter 602 arranged to broadcast information about an access point. The base station 600 is preferably co-located with an access point such that the pure broadcast telecommunication cell and the access area of the access point cover essentially the same area. The transmitter 602 is provided with a synchronisation signal to be transmitted from a synchronisation signal generator 604. The transmitter 602 is also provided with a broadcasting signal to be transmitted from a broadcasting signal generator 606. The synchronisation signal and the broadcasting signal are transmitted on a synchronisation channel and a broadcasting channel, respectively, according to the specifications of the cellular system in which the base station 600 is arranged to work.

FIG. 7 is a flow chart schematically illustrating a method for operating the pure broadcasting base station described above with reference to FIGS. 4 and 6. The operation consist of providing synchronisation for mobile stations in a synchronisation provision step 700, and broadcasting information comprising information about an access point, in a broadcasting step 702.

FIG. 8 is a flow chart schematically illustrating a method for providing information about the pure broadcasting telecommunication cell described above with reference to FIGS. 4 and 6. It is performed by another base station operating another telecommunication cell as described with reference to FIGS. 2 and 3, wherein the another telecommunication cell has considerably larger coverage area than an access area of the access point and than the pure broadcasting telecommunication cell, and the pure broadcasting cell is substantially located within the another telecommunication cell. The information provision comprises including the pure broadcasting cell, i.e. an identification of the pure broadcasting cell and preferably relevant parameters for the pure broadcasting cell, such as frequencies, codes, etc., in a neighbour cell list in a neighbour cell list generation step 800. This step 800 is preferably performed at system setup. The information provision further comprises a neighbour cell list provision step 802 where the generated neighbour cell list is provided to mobile stations camping on the another base station. Thus, this step 802 is performed frequently during operation of the cellular telecommunication system.

The apparatuses of the present invention are implementable with hardware, but the operation of the apparatuses are preferable performed with aid of software. The computer program preferably comprises program code, which is stored on a computer readable medium, which can be loaded and executed by a processing means to cause it to perform the above described methods comprising operating a base station, the operating consisting of providing synchronisation for mobile stations, and broadcasting information comprising information about an access point from the base station operating a pure broadcasting telecommunication cell.

The program code can further cause the processing means to perform providing information about the pure broadcasting telecommunication cell by another base station operating another telecommunication cell. The program code can further cause the processing means to include the pure broadcasting telecommunication cell within a neighbour cell list, and provide the neighbour cell list to mobile stations within or in vicinity to the another telecommunication cell. The program code can further cause the processor to include advertising information into the information to be broadcasted. Here, advertising means not strictly to sell a product or service to the general public but may include political parties, interest groups, militaries, and other organizations looking for new recruits, organizations providing information, and public service announcements.

The program code can also be arranged to operate the mobile station as demonstrated above with reference to FIG. 5. The processing means and computer program product can be arranged to execute the program code sequentially where actions are performed stepwise, but mostly be arranged to execute the program code on a real-time basis where actions are performed upon need and availability of data. The processing means is preferably what normally is referred to as an embedded system.

1-15. (canceled)

16. A method of operating a base station, comprising:
providing synchronization for mobile stations; and
broadcasting information comprising information about an access point enabling generic access network (GAN) communication from the base station;
wherein the base station operates a pure broadcasting telecommunication cell; and
wherein an access area of the access point and the pure broadcasting telecommunication cell cover essentially the same area, such that mobile stations able to receive the broadcasting information become aware of accessibility to the access point.

17. The method of claim 16, wherein the broadcasted information further comprises advertising information.

18. The method of claim 16, further comprising:
providing information about the pure broadcasting telecommunication cell by another base station operating another telecommunication cell, wherein the another telecommunication cell has considerably larger coverage area than the access area of the access point and than the pure broadcasting telecommunication cell, and wherein the pure broadcasting cell is substantially located within the another telecommunication cell.

19. The method of claim 18, wherein providing information about the pure broadcasting telecommunication cell further comprises
including the pure broadcasting telecommunication cell within a neighbor cell list; and
providing the neighbor cell list to mobile stations within or in vicinity to the another telecommunication cell.

20. A base station, comprising:
a transmitter arranged to broadcast information about an access point enabling generic access network (GAN) communication;
wherein the base station is arranged to operate a pure broadcasting telecommunication cell; and
wherein the base station is arranged together with the access point such that the pure broadcast telecommunication cell and an access area of the access point cover essentially the same area.

21. The base station of claim 20, wherein
the pure broadcasting telecommunication cell is arranged substantially within another telecommunication cell operated by another base station;
the another telecommunication cell has considerably larger coverage area than the access area of the access point, and than the pure broadcasting telecommunication cell, and
information about the pure broadcasting telecommunication cell is provided from the another base station of the another telecommunication cell.

22. The base station of claim 20, further being arranged to broadcast advertising information.

23. A mobile station having both abilities for cellular communication and generic access network (GAN) communication, the mobile station having a mode of operation, in which it is operative to:
synchronize with a pure broadcasting base station; and
receive broadcast messaging from the pure broadcasting base station about an access point enabling GAN communication, from the pure broadcasting base station operating a pure broadcasting telecommunication cell;
wherein an access area of the access point and the pure broadcasting telecommunication cell cover essentially the same area such that when the mobile station is able to receive the broadcasting information it becomes aware of accessibility to the access point.

24. The mobile station of claim 23, further arranged to enable entering the mode of operation upon reception of information about presence of the pure broadcasting telecommunication cell from a base station operating a presently operating two-way telecommunication cell having considerably larger coverage area than the access area of the access point and than the pure broadcasting telecommunication cell, the reception comprising information about the pure broadcasting telecommunication cell located substantially within the presently operating telecommunication cell.

25. The mobile station of claim 23, wherein the mobile station is further arranged to start accessing the GAN when the broadcasting information about the access point is received from the pure broadcasting base station.

26. The mobile station of claim 23, wherein the mobile station is further arranged to receive broadcasted advertising information from the pure broadcasting base station.

27. The mobile station of claim 23, wherein the mobile station is further arranged to receive a neighbor cell list comprising information about the pure broadcasting telecommunication cell.

28. A telecommunication system comprising
at least an access point arranged to provide access to a generic access network (GAN);
at least a base station arranged to operate a pure broadcasting telecommunication cell associated with the access point; and
at least a mobile station arranged to operate with the base station and the access point;
wherein an access area of the access point and the pure broadcasting telecommunication cell cover essentially the same area such that when the mobile station is able to receive broadcasting information in the pure broadcasting telecommunication cell it becomes aware of accessibility to the access point.

29. The telecommunication system according to claim 28, further comprising:
at least another base station arranged to operate a cell for telecommunication, the another base station providing information about the pure broadcasting telecommunication cell;
wherein the pure broadcasting telecommunication cell is located substantially within an area of the cell for telecommunication, and wherein the cell for telecommunication has considerably larger coverage area than the access area of the access point and than the pure broadcasting telecommunication cell.

30. A machine readable medium including computer program instructions, which when executed by a processor are operative to cause the processor to perform the process of:
providing synchronization for mobile stations; and
broadcasting information comprising information about an access point enabling generic access network (GAN) communication from the base station;
wherein the base station operates a pure broadcasting telecommunication cell; and
wherein an access area of the access point and the pure broadcasting telecommunication cell cover essentially the same area, such that mobile stations able to receive the broadcasting information become aware of accessibility to the access point.
